(19) United States
(12) Patent Application Publication
(10) Pub. No.: US 2021/0182752 A1
(43) Pub. Date: Jun. 17, 2021

(54) COMMENT-BASED BEHAVIOR PREDICTION

(71) Applicant: BEIJING DIDI INFINITY TECHNOLOGY AND DEVELOPMENT CO., LTD., Beijing (CN)

(72) Inventors: Conghui FU, Santa Clara, CA (US); Xin CHEN, Sunnyvale, CA (US); Dong LI, Santa Clara, CA (US); Jing CHEN, Palo Alto, CA (US)

(21) Appl. No.: 16/718,036

(22) Filed: Dec. 17, 2019

(51) Int. Cl. G06Q 10/06; G06N 5/04; G06N 20/00; G06F 40/232

(52) U.S. Cl. CPC G06Q 10/06311; G06N 5/04; G06F 40/232; G06Q 10/06393; G06N 20/00

(57) ABSTRACT

Negative driver behaviors may be captured based on passenger comments. A set of comments from a set of first users may be obtained. A set of preprocessed words may be generated based on the set of comments. A numerical vector may be generated based on the set of words. A sparse matrix may be generated based on the numerical vector. The sparse matrix may be input into a trained model. A second user may be classified based on an output of the trained model.

### TECHNICAL FIELD

The disclosure relates generally to capturing negative driver behaviors based on passenger comments on a ride sharing platform.

### BACKGROUND

Under traditional approaches, ridesharing platforms may be able to connect passengers and drivers on relatively short notice. However, traditional ridesharing platforms suffer from a variety of safety and security risks for both passengers and drivers. Comments from passengers are an important channel to collect negative driver behaviors. However, manual review has a high cost and low efficiency due to the high volume of comments (e.g., tens of thousands of comments per day). For example, manual review may require interacting with complicated graphical user interfaces, comments may be manually reviewed long after the comments were received, and/or may be otherwise computationally inefficient and/or computationally expensive.

### SUMMARY

Various embodiments of the specification include, but are not limited to, systems, methods, and non-transitory computer readable media for classifying users. Comments may be automatically recognized and/or processed (e.g., in real-time) based on machine learning. This may, for example, provide a computationally efficient way to process (e.g., label) negative and/or positive comments timely and with low costs (e.g., computational cost, user cost).

In various implementations, a method may include obtaining a set of comments from a set of first users and generating a set of preprocessed words based on the set of comments. The method may further include generating a numerical vector based on the set of words and generating a sparse matrix based on the numerical vector. The method may further include inputting the sparse matrix into a trained model and classifying a second user based on an output of the trained model.

In another aspect of the present disclosure, a computing system may comprise one or more processors and one or more non-transitory computer-readable memories coupled to the one or more processors and configured with instructions executable by the one or more processors. Executing the instructions may cause the system to perform operations. The operations may include obtaining a set of comments from a set of first users and generating a set of preprocessed words based on the set of comments. The operations may further include generating a numerical vector based on the set of words and generating a sparse matrix based on the numerical vector. The operations may further include inputting the sparse matrix into a trained model and classifying a second user based on an output of the trained model.

Yet another aspect of the present disclosure is directed to a non-transitory computer-readable storage medium configured with instructions executable by one or more processors to cause the one or more processors to perform operations. The operations may include obtaining a set of comments from a set of first users and generating a set of preprocessed words based on the set of comments. The operations may further include generating a numerical vector based on the set of words and generating a sparse matrix based on the numerical vector. The operations may further include inputting the sparse matrix into a trained model and classifying a second user based on an output of the trained model.

In some embodiments, the set of comments may be obtained through a ride sharing service after a trip.

In some embodiments, the set of first users may include passengers of the ride sharing service and the second user may include a driver of the ride sharing service.

In some embodiments, classifying the driver may include classifying the driver as at least one of a safe driver, a dangerous driver, and an abusive driver.

In some embodiments, generating the set of preprocessed words may include removing the stop word, accents and special symbols from the set of comments. A set of important words may be determined from the set of comments. Typographical errors and abbreviations in the set of important words may be corrected and standardized. The set of preprocessed words may be generated by replacing similar words in the set of important words with standardized words.

In some embodiments, determining the set of important words may include calculating a term frequency-inverse document frequency of each word in the set of comments.

In some embodiments, the numerical vector may be generated by transforming each word in the set of preprocessed words into a numerical value.

In some embodiments, the sparse matrix may include a set of non-zero values from the numerical vector and a set of indexes of the non-zero values.

In some embodiments, a set of tags may be obtained from the set of first users. The set of tags may be associated with at least one comment of the set of comments. A likelihood of whether each tag of the set of tags is correct may be determined based on the classification of the second user.

In some embodiments, the trained model may be trained based on a set of historical comments associated with a set of historical driver classifications.

In some embodiments, training the trained model may include correcting false negative classifications and false positive classifications in the set of historical driver classifications.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an example environment to which techniques for classifying drivers may be applied, in accordance with various embodiments.

FIG. 2 illustrates a flowchart of an example process for preprocessing words, according to various embodiments of the present disclosure.

FIG. 3A illustrates a block diagram of an example process for fixing typographical errors and abbreviations, according to various embodiments of the present disclosure.

FIG. 3B illustrates a block diagram of an example process for transforming words into a numerical vector, according to various embodiments of the present disclosure.

FIG. 4 illustrates a flowchart of an example method, according to various embodiments of the present disclosure.

FIG. 5 is a block diagram that illustrates a computer system 500 upon which any of the embodiments described herein may be implemented.

### DETAILED DESCRIPTION OF THE EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

The approaches disclosed herein may predict behaviors and/or incidents based on user comments (e.g., negative comments). For example, behaviors may include an incident and/or a pre-cursor to an incident. An incident may be a physical incident (e.g., property loss, physical or verbal harm to passengers by the driver and/or vice versa). Various categories of negative driver behaviors may be captured based on the comments from passengers on the ridesharing platform. It is important to utilize passengers' comments on bad drivers' behaviors on a ride-sharing platform in order to prevent other events and/or worse events from happening. There are several challenges in analyzing comments. There may few be comments for drivers classified as safe, and it may be hard to extract general information from the comments. Passengers may incorrectly tag comments about dangerous drivers. Comments may include inconsistently formatted data which may cause analysis to be misconducted. For example, comments may include typographical errors, accents (e.g. a) and abbreviations. Criminal comments may not be labeled as crimes. Even if passengers leave negative comments about a driver, the passengers may not report the driver (e.g., to customer service department), and these cases may not be labeled as criminal cases. Negative comments of different categories (e.g. mistreatment of a passenger, dangerous driving) may be identified from various sources on a ridesharing platform. Although the example of user comments to predict driver behaviors are described herein, it will be appreciated that the systems and methods described herein may also be used to predict passenger behaviors based on driver comments, passenger behaviors based on other passenger comments, and/or the like.

In some embodiments, the ridesharing platform may correct driver classifications received from passengers. For example, passengers may tag submitted comments with a category of driver behavior. However, the passenger classification may be incorrect. For example, the passenger may not provide a driver classification, while commenting about abuse. In another example, the passenger may tag a comment about a driver as abuse when the driver drove dangerously. The ridesharing platform may classify the driver based on the comment, and correct the passenger classification if needed.

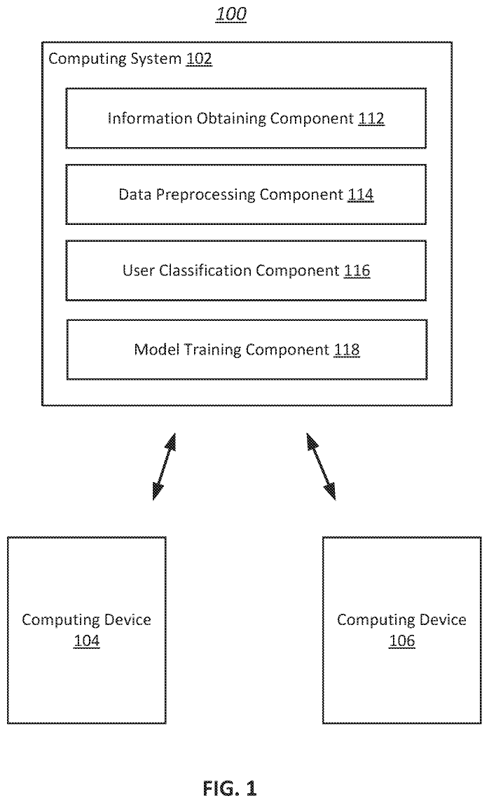

FIG. 1 illustrates an example environment 100 to which techniques for classifying drivers may be applied, in accordance with various embodiments. The example environment 100 may include a computing system 102, a computing device 104, and a computing device 106. It is to be understood that although two computing devices are shown in FIG. 1, any number of computing devices may be included in the environment 100. Computing system 102 may be implemented in one or more networks (e.g., enterprise networks), one or more endpoints, one or more servers, or one or more clouds. A server may include hardware or software which manages access to a centralized resource or service in a network. A cloud may include a cluster of servers and other devices which are distributed across a network.

The computing devices 104 and 106 may be implemented on or as various devices such as a mobile phone, tablet, server, desktop computer, laptop computer, vehicle (e.g., car, truck, boat, train, autonomous vehicle, electric scooter, electric bike), etc. The computing system 102 may communicate with the computing devices 104 and 106, and other computing devices. Computing devices 104 and 106 may communicate with each other through computing system 102, and may communicate with each other directly. Communication between devices may occur over the internet, through a local network (e.g., LAN), or through direct communication (e.g., BLUETOOTH™, radio frequency, infrared).

While the computing system 102 is shown in FIG. 1 as a single entity, this is merely for ease of reference and is not meant to be limiting. One or more components or one or more functionalities of the computing system 102 described herein may be implemented in a single computing device or multiple computing devices. The computing system 102 may include a the information obtaining component 112, a data preprocessing component 114, a user classification component 116, and a model training component 118. The computing system 102 may include other components. The computing system 102 may include one or more processors (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) and memory (e.g., permanent memory, temporary memory). The processor(s) may be configured to perform various operations by interpreting machine-readable instructions stored in the memory. The computing system 102 may be installed with appropriate software (e.g., platform program, etc.) and/or hardware (e.g., wires, wireless connections, etc.) to access other devices of the environment 100.

The information obtaining component 112 may be configured to obtain a set of comments from a set of first users. In some embodiments, the set of comments may be obtained through a ride sharing service after a trip. The set of comments may include a single comment or multiple comments. For example, the comments may be received through a ride sharing platforms on computing devices 104 and 106. In some embodiments, a set of scores may be received from the set of first drivers. For example, the set of scores may include ratings received after the completion of trips on a ride sharing platform. In some embodiments, the set of comments obtained from the set of first users may related to a second user.

In some embodiments, the set of first users may include drivers of the ride sharing service, and the second user may include a passenger. For example, comments may be received from multiple drivers after they complete trips though the ride sharing platform. Comments which relate to the same passenger may be grouped together. For example, the set of comments may include comments from multiple drivers relating to a single passenger.

In some embodiments, the set of first users may include passengers of the ride sharing service, and the second user may include a driver. For example, comments may be received from multiple passengers after being dropped off. Comments may be grouped based on the drivers which drove the passengers. For example, the set of comments may include comments from multiple passengers relating to a single driver.

In some embodiments, comments may include official comments obtained after a trip, or informal communications obtained during a trip. For example, official comments obtained after a trip may include that the car is clean or dirty, that the driver drove poorly, and that the driver was aggressive. Informal communications obtained during a trip may include verbal conversations between a passenger and a driver. Informal communications may include flagged speech. For example, flagged speech may include the driver asking passenger for their phone number, expletives, and threats. Informal communications may be obtained from computing devices 104 and 106.

In some embodiments, a set of tags may be obtained from the set of first users. The set of tags may be associated with at least one comment of the set of comments. For example, the tags may include a string of text entered by the user, or one or more selections from a list of tags (e.g., preset in the ride sharing platform). In some embodiments, tags may be grouped into classifications. For example, tags may be classified based on attitude (e.g., rude, nice, aggressive) and driving habits (e.g., safe, dangerous). In some embodiments, tags may be used to group the comments into different categories. Examples of categories include abuse (e.g., verbal abuse, physical abuse, sexual abuse, assault, battery), dangerous driving (e.g., speeding, swerving, causing an accident), and a good driver.

In some embodiments, the information obtaining component 112 may be configured to obtain information relating to the second user. The information may include personal information and historical records. For example, personal information may include the name, age, gender, and home address of the second user. Personal information may additionally include on or more numbers or strings used to identify the user (e.g., ID number). The historical records may include historical driving behavior and criminal records. The historical records may include order information, driver information and passenger information associated with the historical driving behavior and crimes.

In some embodiments, the information obtaining component 112 may be configured to obtain third party data. Third party data may include natural language processing and language translation information. For example, the third party data may include information for translating accents from one language (e.g., local language) to another language (e.g., English). In another example, the third party data may include general stop words in a local language. Stop words may include a list of common words which will appear frequently in text (e.g. the, and, to), and as a result, provide limited utility for natural language processing. In another example, the third party data may be used to correct spelling errors. For example, the third party data may include a pre-trained word vector model (e.g. word2vec-GoogleNews-vectors). The pre-trained word vector model may be used to correct typographical errors.

The data preprocessing component 114 may be configured to generate a set of preprocessed words based on the set of comments. In some embodiments, generating the set of preprocessed words may include removing the stop word, accents, and special symbols from the set of comments. For example, a regular expression (regex) may be used to find and remove the stop word, accents and special symbols.

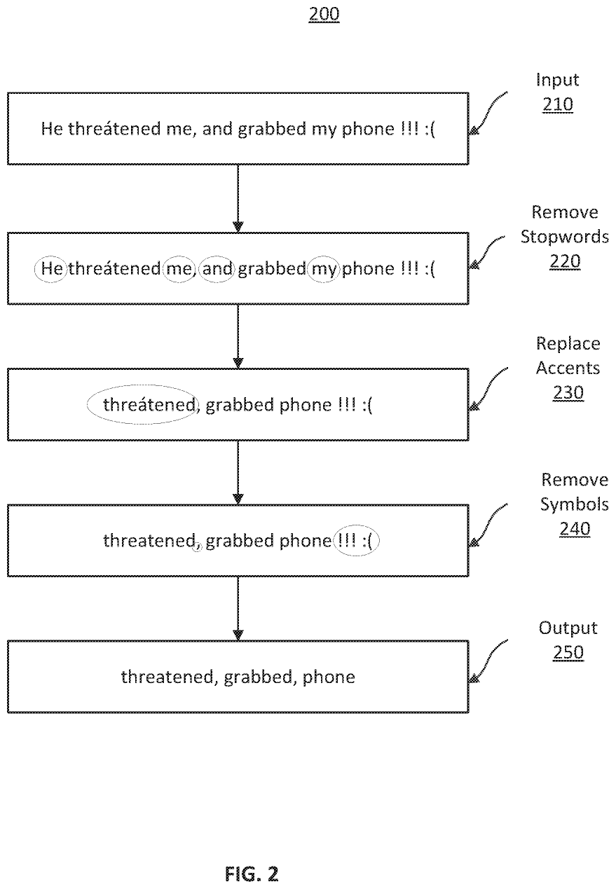

FIG. 2 illustrates a flowchart of an example process 200 for preprocessing words, according to various embodiments of the present disclosure. The process 200 may be implemented using the data preprocessing component 114 of FIG. 1. The process 200 may begin by receiving an input at 210. The input 210 may include a comment from the set of comments. For example, input 210 may include the comment “He threatened me, and grabbed my phone !!! :(”. At 220, stop words may be removed from the comment. Different lists of stop words may be used based on the language of the comment. For example, stop words “He”, “me”, “and”, and “my” may be remove from the comment. At 230, accents may be replaced. Characters may be converted to the closest a-z ascii character. For example, “a” may be replaced with “a”. At 240, special symbols may be removed. Special characters may be deleted, or replaced with a separator (e.g., comma, space, tab, colon, dash). A set of preprocessed words may be output at 250. Although the words shown in output 250 are separated with commas, any separator may be used (e.g., comma, space, tab, colon, dash).

Returning to FIG. 1, in some embodiments, the data preprocessing component 114 may be configured to determine a set of important words from the set of comments. In some embodiments, determining the set of important words may include calculating a term frequency-inverse document frequency (TF-IDF) of each word in the set of comments. For example, TF-IDF may be calculated using the following formula:

$${w}_{i , j} = {tf}_{i , j} \times log ( \frac{N}{{df}_{i}} ) \qquad ( 1 )$$

wherein tf_{i,j}=the number of occurrences of word i in document j, d fᵢ=number of documents containing word i, and N=the total number of documents. The TF-IDF may indicate the importance of a word to a string (e.g., comment, document) in a collection of strings (e.g., list of comments, corpus of documents). The more a word is used in the string, the higher the TF-IDF will be. The TF-IDF will be reduced based on the number of strings in the collection which include the word. As a result, less common word will have a higher TF-IDF, and frequently used words will have a lower TF-IDF.

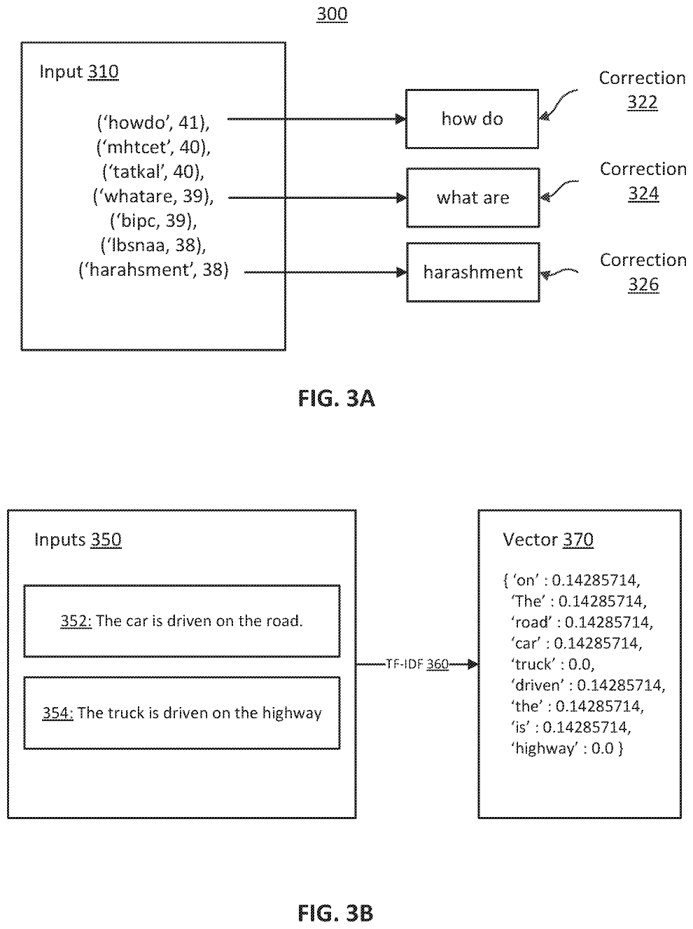

In some embodiments, typographical errors and abbreviations in the set of important words may be corrected and standardized. Typographical errors may be corrected and abbreviations may be standardized using a model. For example, the model may include a dictionary in the native language. The dictionary may include phrases, as well as individual words. FIG. 3A illustrates a block diagram of an example process 300 for fixing typographical errors and abbreviations, according to various embodiments of the present disclosure. Input 310 may include a list of misspelled words. For example, words not listed in a dictionary may be identified. In some embodiments, input 310 may be limited to only include important words. A model may be used to make corrections 322, 324, and 326. In some embodiments, the model may not be able to correct the spelling of some words. For example, the model may not be able to associate these words with a correct spelling. In some embodiments, these words may be removed from the set of important words.

Returning to FIG. 1, in some embodiments, the data preprocessing component 114 may be configured to generate the set of preprocessed words by replacing similar words in the set of important words with standardized words. In some embodiments, word combinations may be used to determine the similar words from the set of important words. For example, a list of similar words may include {opened, opened the, opened the trunk, open, open the, open the trunk, open the door}. In another example, a list of similar words may include {abrio, abrio la, abrio la cajuela, abrir, abrir la, abrir la cajuela}. The similar words may then be replaced with the standardized similar word (e.g., open, abrir).

The data preprocessing component 114 may be configured to generate a numerical vector based on the set of preprocessed words. In some embodiments, the numerical vector may be generated by transforming each word in the set of preprocessed words into a numerical value. The numerical values may be calculated using TF-IDF. For example, equation 1 above may be used to calculate the numerical values. FIG. 3B illustrates a block diagram of an example process 350 for transforming words into a numerical vector, according to various embodiments of the present disclosure. Inputs 360 may include sentences 352 and 354. TF-IDF 360 may be applied to each word to generate numerical values. Vector 370 may be created based on the numerical values of each word.

Returning to FIG. 1, the data preprocessing component 114 may be configured to generate a sparse matrix based on the numerical vector. In some embodiments, the sparse matrix may include a set of non-zero values from the numerical vector and a set of indexes of the non-zero values. In some embodiments, the numerical vector generated through natural language processing may include values for thousands of words. Many of the values may be zero (e.g., the word does not appear in a comment). A spare matrix allows the same information to be stored in a smaller data structure. A Sparse matrix is a special storage format which only stores the non-zero elements. This technique may save storage space and increase calculating.

The user classification component 116 may be configured to input the sparse matrix into a trained model and classify a second user based on an output of the trained model. While the process for classifying a single second user is disclosed, it is to be understood that this process may be repeated for multiple second users. In some embodiments, the second user may be a passenger of a ride sharing service. In some embodiments, the second user may be a driver of a ride sharing service. In some embodiments, computing system 102 may store a database of classifications for multiple drivers and multiple riders who use a ride sharing platform. For example, a database may include all the users of the ride sharing platform in a region (e.g., city, county, state, county).

In some embodiments, drivers may be classified as at least one of a safe driver, a dangerous driver, or an abusive driver. In some embodiments, passengers may be classified as safe passengers or abusive passengers. In some embodiments, the output of the trained model may include at least one safety score and users may be classified based on the at least one safety score. For example, the trained model may include an abuse model and output an abuse probability score. The abuse probability score may indicate the likelihood of the user committing abuse (e.g., verbal abuse, physical abuse, sexual abuse, assault, battery). In another example, the trained model may include a dangerous driving and output a dangerous driving probability score. The dangerous driving probability score may indicate the likelihood of the driver driving recklessly (e.g., speeding, swerving, causing an accident).

In some embodiments, a likelihood of whether each tag of the set of tags obtained from the set of first users (e.g., passengers, drivers) is correct may be determined based on the classification of the second user. For example, if a driver is tagged as a safe driver, and the trained model outputs a high dangerous driving probability score, there may be a low likelihood that the tag is correct. In another example, a passenger may incorrectly tag an unsafe driver (e.g., tagging dangerous driving as abuse). In this example, a high driving probability score and low abuse probability score may be calculated, and it may be determine that the tag has a low likelihood of being correct.

The model training component 118 may be configured to train the trained model based on a set of historical comments associated with a set of historical driver classifications. Training data may be extracted from the historical comments. For example, comments may be extracted for both good and bad drivers. The trained model may be trained to fit the historical driver classifications. In some embodiments, weights may be used to adjust imbalanced tag distributions. For example, a large number of passengers may not provide tags. Infrequent tags may receive a higher weight.

In some embodiments, training the trained model may include correcting false negative classifications and false positive classifications in the set of historical driver classifications. For example, a negative comment may be labeled as a false negative if the passenger does not report the driver to the platform. The false negative may be corrected using manual iteration. In another example, false positive cases (e.g., safe driver labeled as dangerous) may be extracted, and manually reviewed to correct the wrong labels. After correction, the new data may get re-trained. This may improve the model recall and precision.

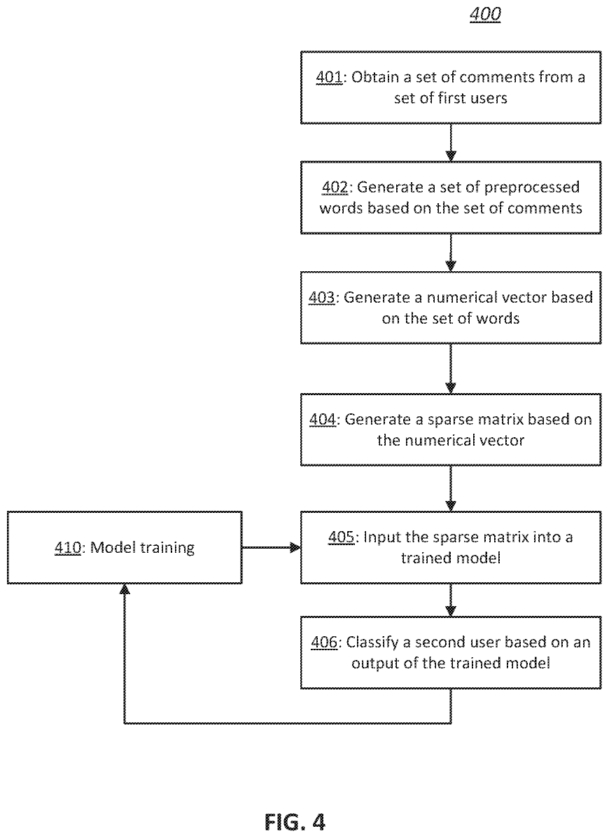

FIG. 4 illustrates a flowchart of an example method 400, according to various embodiments of the present disclosure. The method 400 may be implemented in various environments including, for example, the environment 100 of FIG. 1. The method 400 may be performed by computing system 102. The operations of the method 400 presented below are intended to be illustrative. Depending on the implementation, the method 400 may include additional, fewer, or alternative steps performed in various orders or in parallel. The method 400 may be implemented in various computing systems or devices including one or more processors.

With respect to the method 400, at block 401, a set of comments from a set of first users may be obtained. At block 402, a set of preprocessed words may be generated based on the set of comments. At block 403, a numerical vector may be generated based on the set of words. At block 404, a sparse matrix may be generated based on the numerical vector. At block 405, the sparse matrix may be input into a trained model. At block 406, a second user may be classified based on an output of the trained model. At 410, the model may be trained. The model may initially be trained using training data, and iteratively updated as second users are classified.

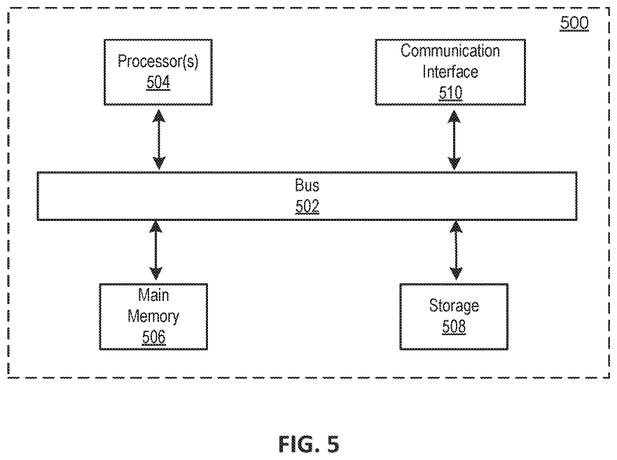

FIG. 5 is a block diagram that illustrates a computer system 500 upon which any of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor(s) 504. Main memory 506 also may be used for storing temporary variables or other intermediate information during execution of instructions to be executed by processor(s) 504. Such instructions, when stored in storage media accessible to processor(s) 504, render computer system 500 into a special-purpose machine that is customized to perform the operations specified in the instructions. Main memory 506 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 508. Execution of the sequences of instructions contained in main memory 506 causes processor(s) 504 to perform the process steps described herein.

For example, the computing system 500 may be used to implement the computing system 102, the information obtaining component 112, the data preprocessing component 114, the user classification component 116, and the model training component 118 shown in FIG. 1. As another example, the process/method shown in FIGS. 2-4 and described in connection with this figure may be implemented by computer program instructions stored in main memory 506. When these instructions are executed by processor(s) 504, they may perform the steps of methods 200, 300, and 400 as shown in FIG. 2-4 and described above. In alternative embodiments, hard-wired circuitry may be used in place of or in combination with software instructions.

The computer system 500 also includes a communication interface 510 coupled to bus 502. Communication interface 510 provides a two-way data communication coupling to one or more network links that are connected to one or more networks. As another example, communication interface 510 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 102 may be described as performing or configured for performing an operation, when the components may comprise instructions which may program or configure the computing system 102 to perform the operation.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A method for classifying users, comprising:
obtaining a set of comments from a set of first users;
generating a set of preprocessed words based on the set of comments;
generating a numerical vector based on the set of words;
generating a sparse matrix based on the numerical vector;
inputting the sparse matrix into a trained model; and
classifying a second user based on an output of the trained model.

2. The method of claim 1, wherein the set of comments are obtained through a ride sharing service after a trip.

3. The method of claim 2, wherein the set of first users comprise passengers of the ride sharing service; and
wherein the second user comprises a driver of the ride sharing service.

4. The method of claim 3, wherein classifying the driver comprises:
classifying the driver as at least one of a safe driver, a dangerous driver, and an abusive driver.

5. The method of claim 1, wherein generating the set of preprocessed words comprises:
removing stop words, accents, and special symbols from the set of comments;
determining a set of important words from the set of comments;
correcting typographical errors and standardizing abbreviations in the set of important words; and
replacing similar words in the set of important words with standardized words.

6. The method of claim 5, wherein determining the set of important words comprises:
calculating a term frequency-inverse document frequency of each word in the set of comments.

7. The method of claim 1, wherein the numerical vector is generated by transforming each word in the set of preprocessed words into a numerical value.

8. The method of claim 1, wherein the sparse matrix comprises a set of non-zero values from the numerical vector and a set of indexes of the non-zero values.

9. The method of claim 1, wherein the method further comprises:
obtaining a set of tags from the set of first users, wherein the set of tags is associated with at least one comment of the set of comments; and
determining a likelihood of whether each tag of the set of tags is correct based on the classification of the second user.

10. The method of claim 1, wherein the method further comprises:
training the trained model based on a set of historical comments associated with a set of historical driver classifications.

11. The method of claim 1, wherein training the trained model further comprises:
correcting false negative classifications and false positive classifications in the set of historical driver classifications.

12. A system for identity and access management, comprising one or more processors and one or more non-transitory computer-readable memories coupled to the one or more processors and configured with instructions executable by the one or more processors to cause the system to perform operations comprising:
obtaining a set of comments from a set of first users;
generating a set of preprocessed words based on the set of comments;
generating a numerical vector based on the set of words;
generating a sparse matrix based on the numerical vector;
inputting the sparse matrix into a trained model; and
classifying a second user based on an output of the trained model.

13. The system of claim 12, wherein the set of comments are obtained through a ride sharing service after a trip.

14. The method of claim 13, wherein the set of first users comprise passengers of the ride sharing service; and
wherein the second user comprises a driver of the ride sharing service.

15. The method of claim 14, wherein classifying the driver comprises:
classifying the driver as at least one of a safe driver, a dangerous driver, and an abusive driver.

16. The method of claim 12, wherein generating the set of preprocessed words comprises:
removing stop words, accents, and special symbols from the set of comments;
determining a set of important words from the set of comments;
correcting typographical errors and standardizing abbreviations in the set of important words; and
replacing similar words in the set of important words with standardized words.

17. The method of claim 16, wherein determining the set of important words comprises:
calculating a term frequency-inverse document frequency of each word in the set of comments.

18. The method of claim 12, wherein the sparse matrix comprises a set of non-zero values from the numerical vector and a set of indexes of the non-zero values.

19. A non-transitory computer-readable storage medium configured with instructions executable by one or more processors to cause the one or more processors to perform operations comprising:
obtaining a set of comments from a set of first users;
generating a set of preprocessed words based on the set of comments;
generating a numerical vector based on the set of words;
generating a sparse matrix based on the numerical vector;
inputting the sparse matrix into a trained model; and
classifying a second user based on an output of the trained model.

20. The non-transitory computer-readable storage medium of claim 19, wherein the set of comments are obtained through a ride sharing service after a trip.
